(19) United States
(12) Patent Application Publication
(10) Pub. No.: US 2011/0058218 A1
(43) Pub. Date: Mar. 10, 2011

(54) PRINTING SYSTEM, PRINTER AND PDL PROCESSING APPARATUS

(75) Inventor: Kiyoji Hane, Azumino-shi (JP)

(73) Assignee: SEIKO EPSON CORPORATION, Shinjuku-ku (JP)

(21) Appl. No.: 12/877,937

(22) Filed: Sep. 8, 2010

(30) Foreign Application Priority Data
Sep. 9, 2009 (JP) 2009-208230

(51) Int. Cl. G06F 3/12

(52) U.S. Cl. 358/1.15

(57) ABSTRACT

A printing system includes a print processing unit that obtains the rasterized bitmap data and is capable of printing an image based on the corresponding bitmap data, a PDL processing unit that is capable of generating bitmap data by interpreting print data with a predetermined page description language, a first bus with the USB standard for connecting the print processing unit and the PDL processing unit, and a second bus for connecting the print processing unit and the PDL processing unit, wherein the print processing unit transmits print data with the corresponding page description language to the PDL processing unit through the first bus and also executes a predetermined communication with the PDL processing unit through the second bus when obtaining print data with the page description language, and the PDL processing unit generates bitmap data by interpreting print data with the transmitted page description language.

### BACKGROUND

1. Technical Field

The present invention relates to a printing system, a printer and a PDL processing apparatus.

2. Related Art

JP-A-2005-210275 discloses the configuration in which circuits and devices (also referred to as option boards) are added to provide additional functions to the general functions in a device having a printing function such as a printer and so on. Especially in JP-A-2005-210275, a combination device having a PC interface for receiving GDI print data or PDL print data from a PC, and a function for executing print processing based on the received GDI print data is disclosed, wherein in the case of having a PDL option board, when PDL print data are received through the PC interface, the PDL print data are processed in the PDL option board and then print processing is performed based on the image data which have been processed such as rasterizing by the PDL option board.

In the configuration of adding an option board to a device (the main device) having the printing function of the above-described printer, communication speed (also referred to as bandwidth) between the main device and the option board (in JP-A-2005-210275, between a combination device and the PDL option board) can be a problem. That is, for the main device, in order to implement the desired print speed (for example, the number of items printed per unit time) required on a product, a communication speed between the option board and the main device (in JP-A-2005-210275, a communication speed in transmitting an image data processed by a PDL option board to a printer of a combination device) should be maintained at equal to or greater than a predetermined value.

In order to implement high speed data communication between the main device and an option board, generally, a bus (for example, PCI Express bus) which can support high speed communication of mass data can be employed for connecting the main device and the option board. However, a bus with high communication speed is expensive and therefore causes a cost increase in a device such as a printer and so on.

### SUMMARY

An advantage of some aspects of the invention is providing a printing system, a printer and a PDL processing apparatus that are capable of implementing high speed printing without increasing the cost, achieved by preventing a communication speed reduction between a device having a printing function and a device for adding additional functions to a main device.

One aspect of the invention is a printing system, which includes a print processing unit that obtains rasterized bitmap data and is capable of printing an image based on the corresponding bitmap data, a PDL processing unit that is capable of generating bitmap data by interpreting print data with a predetermined page description language, a first bus with the USB standard for connecting the print processing unit and the PDL processing unit, and a second bus for connecting the print processing unit and the PDL processing unit, wherein the print processing unit transmits print data with the corresponding page description language to the PDL processing unit through the first bus and also executes a predetermined communication with the PDL processing unit through the second bus when obtaining print data with the page description language, and the PDL processing unit generates bitmap data by interpreting print data with the transmitted page description language and outputs the generated corresponding bitmap data to the print processing unit through the first bus.

According to the invention, in the case of printing based on print data with page description language, the various communication data other than print data and the generated bitmap data are communicated between the print processing unit and the PDL processing unit through the second bus which is configured separately from the first bus. Therefore, without employing the high cost of a bus or an interface to achieve high speed communication between the print processing unit and the PDL processing unit, it is possible to prevent communication speed (bps) reduction when transmitting bitmap data from the PDL processing unit to the print processing unit, thereby, allowing for a high speed print. The second bus is a bus that has a slower or equivalent communication speed to the first bus, and, for example, it can be a serial bus.

The print processing unit transmits a signal inquiring of the status and/or the result of performance of bitmap data generation to the PDL processing unit through the second bus, and the PDL processing unit returns a response to the inquiring signal transmitted by the second bus through the second bus. According to this configuration, even though the performance of bitmap data generation by the PDL processing unit and the executing of communication for inquiring of the status and/or the result of performance of bitmap data generation between the print processing unit and the PDL processing unit are performed at the same time, there is no communication speed loss in the first bus.

To perform print processing of an image based on bitmap data, the print processing unit may include a CPU that has less processing power than the CPU which the PDL processing unit has for performing the bitmap data generation, and memory with a slower processing speed than the memory which the PDL processing unit has for performing the bitmap data generation. According to this configuration, the print processing unit can be implemented inexpensively.

The PDL processing unit compresses the bitmap data in each band including the predetermined number of rasters and outputs the compressed data in each band to the print processing unit through the first bus, and the print processing unit obtains the bitmap data in each band by decompressing (also referred to as deploying or thawing) the compressed data in each band obtained by the first bus and prints an image based on the bitmap data in each band. In accordance with this configuration, since the PDL processing unit outputs bitmap data to the print processing unit by compressing part of a number (a band unit) of rasters consisting of an image corresponding to one page, the data transmission speed from the PDL processing unit to the print processing unit is improved. Furthermore, regarding the memory of the print processing unit such as RAM and so on, since it only needs to have enough capacity to store data in the band units when storing bitmap data transmitted (outputted) from the PDL processing unit, the cost required for the memory can be reduced.

Although a printing system has been described as an aspect of the invention, the invention can be implemented according to systems other than the printing system.

As an aspect of the invention, a printer that obtains rasterized bitmap data and is capable of printing an image based on the corresponding bitmap data is provided, the printer including a first interface corresponding to the USB standard, and a second interface, for connecting to a PDL processing unit, capable of generating bitmap data by interpreting print data with a predetermined page description language, and a bus, wherein when obtaining print data with the page description language, the printer transmits print data with the corresponding page description language to the PDL processing unit through the first interface and also executes a predetermined communication with the PDL processing unit through the second interface, and obtains through the first bus the bitmap data generated by interpretation of the print data with the page description language by the PDL processing unit. Additionally, as an aspect of the invention, a PDL processing apparatus that is equipped in a printer capable of printing an image based on rasterized bitmap data is provided, the PDL processing apparatus including a first interface corresponding to the USB standard, and a second interface, for connecting to the printer and a bus, wherein when obtaining print data with a predetermined page description language through the first interface from the printer, the PDL processing apparatus generates bitmap data by interpreting print data with the corresponding page description language, outputs the generated corresponding bitmap data to the printer through the first bus, and executes a predetermined communication with the printer through the second interface.

That is, for the print processing unit (a printer) and the PDL processing unit (a PDL processing device) making up the printing system, each unit may be regarded as an individual invention. Additionally, the technical spirit of the invention can be implemented by other than the printing system, the print processing unit (the printer) or the PDL processing unit (the PDL processing device). For instance, the invention can be accomplished by a method including processes performed by the printing system, the print processing unit (the printer) or the PDL processing unit (the PDL processing device), or a computer readable program enabling a computer to execute the function performed by the printing system, the print processing unit (the printer) or the PDL processing unit (the PDL processing device).

### BRIEF DESCRIPTION OF THE DRAWINGS

The invention will be described with reference to the accompanying drawings, wherein like numbers reference like elements.

FIG. 1 is a block diagram showing a simplified configuration of a printing system according to the invention.

FIG. 2 is a flow chart showing one example of print processing with respect to input of print data.

FIG. 3 is a flow chart showing one example of performing bitmap data generation.

### DESCRIPTION OF EXEMPLARY EMBODIMENTS

Hereinafter, the embodiments of the invention will be described by referring to the figures.

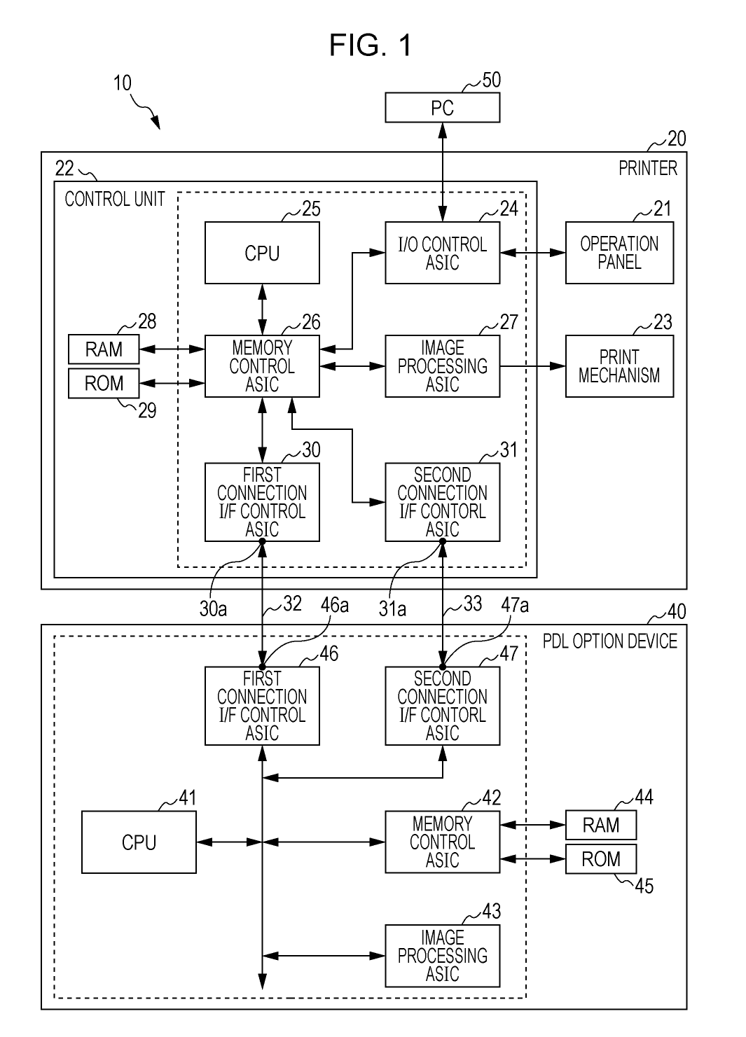

FIG. 1 shows a block diagram of the simplified configuration of the printing system 10 according to the embodiment of the invention. The printing system 10 includes a printer 20 and a PDL (Page Description Language) option device 40. The printer 20 is one example of the print processing unit (a printer) according to the invention, and the PDL option device 40 is one example of the PDL processing unit (a PDL processing device). Furthermore, the printing system 10 is connected to a personal computer (PC) 50 which is a host device for the printer 20.

The printer 20 is, for example, an ink jet printer including an operation panel 21, a control unit 22 and a print mechanism unit 23 and so on. The operation panel 21 is a unit adapted to receive various instructions from the user and to provide the status of the printer 20 to the user. For example, the operation panel 21 is configured by a liquid crystal display, LED and a push-button switch and so on, and is connected to an I/O control ASIC 24. The print mechanism unit 23 is a unit (so-called a print engine) adapted to perform printing on a sheet based on image data outputted from the control unit 22. In the case that the printer 20 is an ink jet printer as described above, the print mechanism unit 23 is provided with a print head which jets each ink based on image data, a reciprocating member, which moves the print head in the main scanning direction, and a paper transportation mechanism, which transports a sheet in the direction perpendicular to the main scanning direction, and so on. Or the printer 20 may merely be a page printer etc. In the PC 50, a printer driver (not shown) is installed for controlling the printer 20.

The control unit 22 is a unit consisting of a CPU 25, a memory control ASIC 26, an image processing ASIC 27, an I/O control ASIC 24, RAM 28, ROM 29, a first connection interface (I/F) control ASIC 30, a second connection I/F control ASIC 31 and so on for controlling the printing system 10. The I/O control ASIC 24 implements a USB interface or an interface for an external network interface, and, in the embodiment of the invention, it is connected to the PC 50 through a fixed cable.

The memory control ASIC 26, the I/O control ASIC 24, the first connection interface (I/F) control ASIC 30, the second connection I/F control ASIC 31 and the image processing ASIC 27 are ASICs for controlling data transmission between various devices connected to each ASIC, or for image processing. The CPU 25, the memory control ASIC 26, the image processing ASIC 27, the I/O control ASIC 24, the first connection interface (I/F) control ASIC 30 and the second connection I/F control ASIC 31 can be configured on a chip (refer to the long dotted line in FIG. 1)

The PDL option device 40 is, for example, one circuit board, and is connected to the printer 20 through a predetermined bus. In other words, the printing system 10 is the printer equipped with the additional PDL option device 40. As described hereinafter, the printing system 10 can perform the print process (as printer 20 itself) with print data with a predetermined format for the configuration which is not equipped with the PDL option device 40.

The PDL option device 40 is a unit consisting of a CPU 41, a memory control ASIC 42, an image processing ASIC 43, RAM 44, ROM 45, a first connection I/F control ASIC 46, a second connection I/F control ASIC 47 and so on. The first connection I/F control ASIC 30 and the first connection I/F control ASIC 46 are provided with the USB interfaces 30a and 46a respectively, and communicatively connected through a USB standard bus 32 between the interfaces 30a and 46a. The second connection I/F control ASIC 31 and the second connection I/F control ASIC 47 are provided with serial interfaces 31a and 47a respectively, and communicatively connected through a serial bus 33 between the interfaces 31a and 47a.

The bus 32 and USB interfaces 30a and 46a correspond to the first bus and the first interfaces. The bus 33 and serial interfaces 31a and 47a correspond to the second bus and the second interfaces. According to the embodiment of the invention, a second bus which has a slower or an equivalent communication speed to the first bus is employed. Considering the cost of the printing system 10, it is preferable to employ a bus (for example, a lower cost bus than the first bus) which has a slower communication speed than the first bus as the second bus, and for instance, serial buses with UART (Universal Asynchronous Receiver Transmitter) standard or SPI (Serial Peripheral Interface) standard as the kinds of serial bus, can be used.

Additionally, for the printer 20, it is possible to configure it to have only one I/F control ASIC instead of both the first connection I/F control ASIC 30 and the second connection I/F control ASIC 31, and also an interface for connecting a bus 32 and an interface for connecting a bus 33 to the I/F control ASIC. In the same way, for the PDL option device 40, it is possible to configure it to have only one I/F control ASIC instead of both the first connection I/F control ASIC 46 and the second connection I/F control ASIC 47, and also an interface for connecting the bus 32 and an interface for connecting a bus 33 to the I/F control ASIC. Furthermore, for the PDL option device 40, the CPU 41, the memory control ASIC 42, the first connection I/F control ASIC 46, the second connection I/F control ASIC 47 and the image processing ASIC 43 can be implemented on a single chip (refer to the long dotted line of the FIG. 1)

With this configuration, the printer 20 is capable of obtaining rasterized bitmap data (data having a gradation value of RGB or CMYK in each pixel) as print data, and printing an image based on the bitmap data. That is, when bitmap data (properly compressed bitmap data) as print data from an external device is input to the control unit 22, the printer 20 generates image data by performing an image process with the image processing ASIC 27 such as decompressing, color converting, and screening (also referred to as halftone processing, binarization and so on) according to the print data requirement. Furthermore, the print mechanism unit 23 executes printing based on the image data when the generated image data is output to the print mechanism unit 23.

However, when obtaining print data (PDL data) described with a predetermined page description language (PDL) as print data, the printer 20 cannot print an image based on the PDL data on its own. That is, the printer 20 is configured so as to have the simplest configuration required to process the relatively low load job of print processing based on rasterized bitmap data. The printer 20 uses the PDL option device 40 capable of executing a high load job such as PDL interpretation etc. when performing print processing based on PDL data. Thus, the CPU 25 included in the printer 20 has low processing power and is less costly than the CPU 41 included in the PDL option device 40. Additionally, the RAM 28 included in the printer 20 has slower processing speed for reading and writing and is less costly than the RAM 44 included in the PDL option device 40.

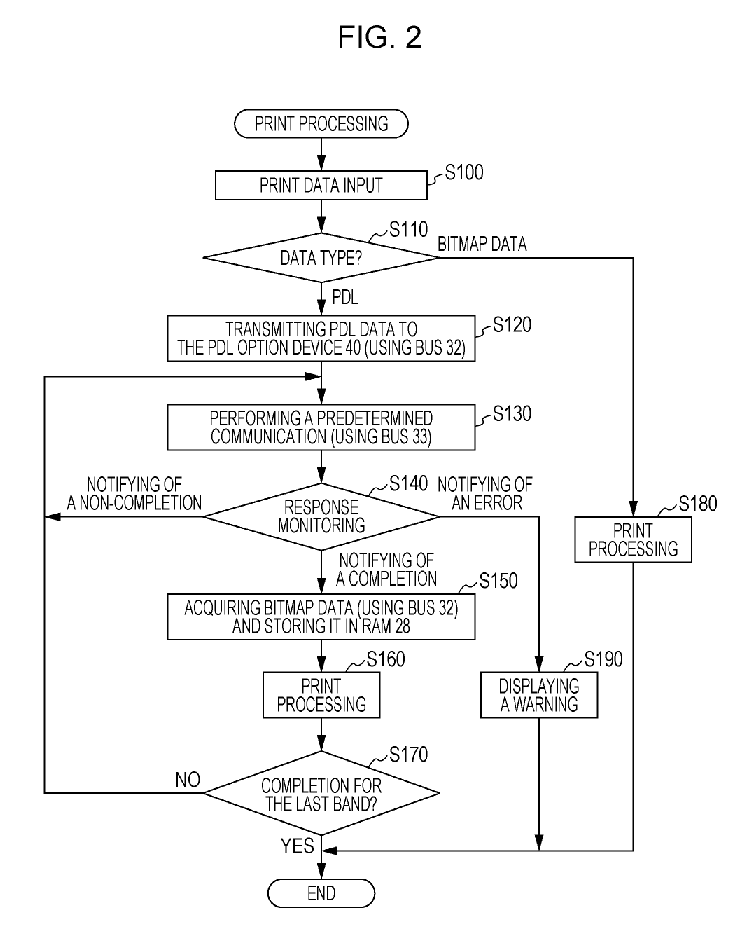

FIG. 2 is a flow chart showing one example of print processing performed by the printing system 10 depending on the print data. This processing is implemented mainly by execution of a predetermined program stored in ROM 29 by a control unit 22 (CPU 25) of the printer 20.

At step S100, the control unit 22 obtains print data as input data from the PC 50 through the I/O control ASIC 24. This obtained print data is referred to as rasterized bitmap data or PDL data.

At step S110, the control unit 22 determines if the input print data is bitmap data or PDL data. The control unit 22, for example, reads header information (data type information describing data type) described in a header of the input print data, thereby determining if it is bitmap data or PDL data based on the header information. The control unit 22, if determining that it is bitmap data, stores print data in the RAM 28, and step S180 proceeds.

At step S180, the control unit 22 performs print processing (image processing by the image processing ASIC 27, outputting the image data generated by the image processing to the print mechanism unit 23 and printing by the print mechanism 23) of the image based on print data (bitmap data) stored in the RAM 28.

On the other hand, if the control unit 22 determines PDL data at step S110, it proceeds to step S120. At step S120, the control unit 22 transfers print data (PDL data) to the PDL option device 40. In this case, the control unit 22 first stores print data in the RAM 28 and then transfers the stored corresponding print data in sequence to the PDL option device 40 through the USB interface 30a of the first connection I/F control ASIC 30 and the bus 32.

At step S130, the control unit 22 performs a predetermined communication with the PDL option device 40 through the bus 33. Here, predetermined communication means any kind of communication required to communicate with the PDL option device 40 in order to implement print processing based on PDL data with the exception of transmitting (step S130) PDL data from the printer 20 to the PDL option device 40 and outputting bitmap data (compressed bitmap data) from the PDL option device 40 to the printer 20.

More specifically, the control unit 22 transmits (step S130) a signal (inquiring command) inquiring of the status and/or the result of performance of bitmap data generation to the PDL option device 40 through the serial interface 31a of the second connection I/F control ASIC 31 and the bus 33 after step S120 or at almost the same time as step S120. The PDL option device 40 receives the corresponding inquiring command through the serial interface 47a of the second connection I/F control ASIC 47, then sends a response to the received inquiring command to the printer 20 through the corresponding serial interface 47a and the bus 33.

Now, the performance of the PDL option device 40 after receiving the transfer of the PDL data is described.

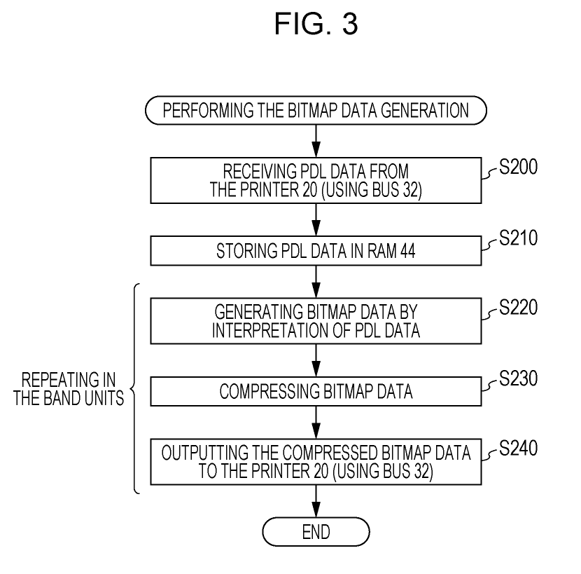

FIG. 3 is a flow chart showing performance of bitmap data generation based on PDL data by the PDL option device 40. This process is implemented mainly by executing a predetermined program stored in the ROM 45 by the CPU 41 of the PDL option device 40.

The PDL option device 40 receives (step S200) print data (PDL data) transmitted from the printer 20 through the USB interface 46a of the first connection I/F control ASIC 46 connected to the bus 32, and then stores (step S210) the received corresponding PDL data in the RAM 44 in the memory control ASIC 42.

At step S220, the PDL option device 40 converts PDL data to intermediate code by interpreting PDL data stored in the RAM 44, and then generates raster data (bitmap data) in the band units on the RAM 44 by deploying the intermediate code in the band units again (deploying all intermediate code included in one band).

According to the embodiment, for example, 1 band=64 rasters. Thus, at step S220, the PDL option device 40 generates bitmap data in image pieces consisting of 64 rasters.

At step S230, the PDL option device 40 performs compression in the image processing ASIC 43 of the bitmap data generated in the band unit, and then writes the data to the RAM 44. The compression method is not limited, but, for example, the image processing ASIC 43 compresses the bitmap data in the band units with a predetermined lossless compression method. In addition, the image processing ASIC 43 can perform a color conversion process for the bitmap data in the band units before the compression.

At step S240, the PDL option device 40 outputs the bitmap data which has been compressed in the band units (compressed bitmap data) to the printer 20 from RAM 44 through the memory control ASIC 42, the USB interface 46a of the first connection I/F control ASIC 46 and the bus 32. The PDL option device 40 performs generation, compression and output of the bitmap data in the band units repetitively for each band consisting of the print object image described by the transmitted PDL data.

Furthermore, the PDL option device 40 responds to the inquiring command. As for the responses to the inquiring command, there is a completion notification for notifying that the generation of one unit (band unit) of compressed bitmap data is completed at that moment, a non-completion notification for notifying that the generation of one unit (band unit) of compressed bitmap data is not completed at that moment, an error notification for notifying that the generation of the bitmap data by PDL data interpretation has failed, and so on. That is, the PDL option device 40 performs the process of bitmap data generation (see FIG. 3) when receiving the PDL data transmission through the bus 32, and at the same time, if receiving an inquiring command of the current status (proceeding level) of the bitmap data generation process through the bus 33, sends a notification (a completion notification, a non-completion notification and an error notification etc.) as the response to the printer 20 through the serial interface 47a of the second connection I/F control ASIC 47 and the bus 33.

Referring to FIG. 2 again, this will be explained further.

At step S140, the control unit 22 monitors a response from the PDL option device 40 through the interface 31a of the second connection I/F control ASIC 31, and then performs the logic on the basis of the content of the obtained response. In this case, if receiving a non-completion notification as a response from the PDL option device 40, the control unit 22 sends an inquiring command again to the PDL option device 40 (step S130), and then continues to monitor. If the control unit 22 receives a completion notification, it proceeds to step S150, and if receiving an error notification, it proceeds to step S190. At step S190, the control unit 22 displays a warning that print based on print data is not possible on the liquid crystal display, for example, by controlling the liquid crystal display of the operation panel 21, and then the flow chart ends.

At step S150, the control unit 22 obtains the compressed bitmap data in the band units from the PDL option device 40, and then stores them in RAM 28. That is, if a completion notification is received from the PDL option device 40 through the bus 33, it means that generation of the compressed bitmap data for one band is completed in the PDL option device 40, and these compressed bitmap data are inputted through the bus 32 and USB interface 30a of the first connection I/F control ASIC 30.

At step S160, the control unit 22 performs image print processing (image processing by the above-mentioned image processing ASIC 27, outputting image data generated by the image processing to the print mechanism unit 23 and printing by the print mechanism 23) based on the compressed bitmap data stored in RAM 28 at step S150. In other words, it generates bitmap data in each band by decompressing the compressed bitmap data in each band on RAM 28, and prints an image based on bitmap data in each corresponding band.

At step S170, the control unit 22 determines if print processing based on the compressed bitmap data is completed for the last band. If the control unit 22 determines that the print processing based on the compressed bitmap data is completed for the last band, the flow chart ends, and if it determines that the print processing based on the compressed bitmap data is not completed for the last band, the process starting from step S130 is repeated. That is, with the repetition of step S130 to S170, printing all bands making up the print object image described by print data (PDL data) is completed.

Furthermore, after transmitting the compressed bitmap data for every band making up the print object image described by the transmitted PDL data to the printer 20, the PDL option device 40 can notify the printer 20 through the bus 33 of its intent to complete the transmission of the compressed bitmap data for all bands. The control unit 22 can determine if the notification is received or not, and thereby if the print processing based on the compressed bitmap data for the last band is completed or not.

Described above in the examples are an inquiring command and a response to the inquiring command (a completion notification, a non-completion notification and an error notification) which are examples of communication between the printer 20 and the PDL option device 40 through the bus 33. However, the communication between the printer 20 and the PDL option device 40 through the bus 33 are not limited to this.

For instance, the PDL option device 40 can give notification of a compression error as a response to the inquiring command. The compression error notification is a signal notifying that the generation of the bitmap data in the band units is completed, but the compression of the corresponding data failed or the compression level is not high enough. As mentioned above, at step S230 (see FIG. 3) the PDL option device 40 can perform the compression of the bitmap data in the band units, but depending on the data, the compression process may fail or even though the compression is partially achieved, the required compression may not be achieved. Therefore, in the case that the compression fails or is not high enough, the PDL option device 40 sends a compression error notification to the printer 20 through the bus 33, and then outputs the bitmap data in the band units which are not compressed at all or are not compressed enough, to the printer 20 through the bus 32. Thus, if a compression error notification is transmitted to the printer 20, the printer 20 (the control unit 22) can perform the process (for example, adjusting print speed, assuring empty capacity in the RAM 28, or selecting the required image process) in the situation when the bitmap data in the band units, which is not compressed at all or is not compressed enough, is transmitted.

Additionally, the control unit 22 can send a command inquiring of the print condition as a communication to the PDL option device 40 through the bus 33. Here, the print condition means, for example, black and white or color, sheet size and so on. The PDL option device 40 can obtain the print condition determined for the corresponding PDL data by interpretation (step S220) of the corresponding PDL data. Besides the inquiring command from the control unit 22 through the bus 33, the PDL option device 40 notifies the control unit 22 of the print condition determined by interpretation of the PDL data as a response to a command inquiring of the print condition through the bus 33 when receiving a command inquiring of the print condition. As a result, the control unit 22 can perform a certain process (for instance, conversion of black and white/color printing, resolution conversion etc.) depending on the notified print condition (black and white/color, sheet size) when performing print processing at step S160.

Furthermore, after determining “Yes” at step S170, the control unit 22 can send an instruction (a delete command) for deleting the bitmap data (compressed bitmap data) generated based on PDL data as a communication through the bus 33 to the PDL option device 40. In other words, after the printing of the print object image described by the PDL data is completed, the control unit 22 sends a delete command to the PDL option device 40, and the PDL option device 40 deletes the bitmap data (compressed bitmap data) stored in the RAM 44 after receiving the delete command. That is, according to the embodiment, considering print errors and the like in the printer 20, the PDL option device 40 does not delete bitmap data (compressed bitmap data) generated based on PDL data until the delete command is transmitted.

Therefore, according to the embodiment, the printer 20 capable of printing based on bitmap data is configured, in which the PDL option device 40 capable of generating bitmap data by interpretation of PDL data is connected, and the printer 20 and the PDL option device 40 are connected by the USB standard bus 32 and the bus 33 (less costly than the bus 32) having typically a slower communication speed than the bus 32 with the USB standard. Furthermore, the printer 20 transmits PDL data to the PDL option device 40 through the bus 32 when acquiring PDL data externally as print data, obtains, through the bus 32, bitmap data (the compressed bitmap data) generated by interpretation of the PDL data by the PDL option device 40, and performs a predetermined communication (transmission of an inquiring command and receipt of a response to the corresponding inquiring command etc.) through the bus 33.

That is, since all other predetermined communication required for the print processing except PDL data transmission from the printer 20 to the PDL option device 40 and bitmap data transmission from the PDL option device 40 to the printer 20 are performed through the bus 33, bandwidth degradation of the bus 32 due to this predetermined communication does not occur. Accordingly, without using a bus that is capable of high speed and mass communication but is expensive, between the printer 20 and the PDL option device 40, it is possible to prevent the reduction of the transmission speed of the bitmap data from the PDL option device 40 to the printer 20, thereby achieving both cost reduction of the product and a high printing speed.

The entire disclosure of Japanese Patent Application No. 2009-208230, filed Sep. 9, 2009 is expressly incorporated by reference herein.

What is claimed is:

1. A printing system, comprising:
a print processing unit that obtains the rasterized bitmap data and is capable of printing an image based on the corresponding bitmap data;
a PDL processing unit that is capable of generating bitmap data by interpreting print data with a predetermined page description language;
a first bus with the USB standard for connecting the print processing unit and the PDL processing unit; and
a second bus for connecting the print processing unit and the PDL processing unit,
wherein the print processing unit transmits print data with the corresponding page description language to the PDL processing unit through the first bus and also executes a predetermined communication with the PDL processing unit through the second bus when obtaining print data with the page description language, and the PDL processing unit generates bitmap data by interpreting print data with the transmitted page description language and outputs the generated corresponding bitmap data to the print processing unit through the first bus.

2. The printing system according to claim 1, wherein the print processing unit transmits a signal for inquiring at least the status and/or the result of performance of the bitmap data generation to the PDL processing unit through the second bus, and the PDL processing unit returns a response to the inquiring signal transmitted by the second bus through the second bus.

3. The printing system according to claim 1, wherein the print processing unit includes a CPU that has a lower processing power than the CPU which the PDL processing unit has for performing the bitmap data generation, and memory that has a slower processing speed than the memory which the PDL processing unit has for performing the bitmap data generation.

4. The printing system according to claim 1, wherein the PDL processing unit compresses the bitmap data in each band including the predetermined number of rasters and outputs the compressed data in each band to the print processing unit through the first bus, and the print processing unit obtains the bitmap data in each band by decompressing the compressed data in each band obtained by the first bus and prints an image based on the bitmap data in each band.

5. The printing system according to claim 1, wherein the second bus is a serial bus that has a slower communication speed than the first bus.

6. A printer that obtains rasterized bitmap data and is capable of printing an image based on the corresponding bitmap data, comprising:
a first interface corresponding to the USB standard, and a second interface, for connecting to a PDL processing apparatus, capable of generating bitmap data by interpreting print data with a predetermined page description language, and a bus,
wherein when obtaining print data with the page description language, the printer transmits print data with the corresponding page description language to the PDL processing apparatus through the first interface and also executes a predetermined communication with the PDL processing apparatus through the second interface, and obtains through the first bus the bitmap data generated by interpretation of the print data with the page description language by the PDL processing apparatus.

7. A PDL processing apparatus that is equipped in a printer capable of printing an image based on rasterized bitmap data, comprising:
a first interface corresponding to the USB standard, and a second interface, for connecting to the printer and a bus,
wherein when obtaining print data with a predetermined page description language through the first interface from the printer, the PDL processing apparatus generates bitmap data by interpreting print data with the corresponding page description language, outputs the generated corresponding bitmap data to the printer through the first bus, and executes a predetermined communication with the printer through the second interface.
